(19) United States
(12) Patent Application Publication
(10) Pub. No.: US 2025/0327349 A1
(43) Pub. Date: Oct. 23, 2025

(54) METHOD AND SYSTEM FOR PROTECTING BUILDINGS WITH GARAGE DOORS AGAINST LARGE LATERAL FORCES

(71) Applicant: Peter William SCHUYLER, Sonoma, CA (US)

(72) Inventor: Peter William SCHUYLER, Sonoma, CA (US)

(21) Appl. No.: 18/640,873

(22) Filed: Apr. 19, 2024

(51) Int. Cl. E05D 15/16; E06B 3/48

(52) U.S. Cl. CPC E05D 15/165; E06B 3/485; E05Y 2800/406; E05Y 2900/106

(57) ABSTRACT

A method and system for securing or buttressing buildings having sectional garage doors against lateral forces as experienced in seismic events or high winds, by releasably securing the panels of the sectional garage door to each other and securing them in a closed position against buttressing columns when the garage door is in its closed configuration, thereby allowing the door to act as a shear wall assembly when closed.

### FIELD OF THE INVENTION

The present invention relates to the field of earthquake and hurricane protection. In particular it deals with protecting buildings with garage or overhead doors, which are closed most of the time.

### BACKGROUND OF THE INVENTION

A standard sectional garage door (hereafter referred to as a sectional door), has horizontal panels that are stacked and interconnected with hinges along their top and bottom abutting horizontal edges. The ends of each panel are provided with guide rollers to allow the panel to travel up a track positioned on each side of the door opening. The tracks keep panels laterally aligned with the door opening and guide the panels to come to rest flush with the door opening when the door is closed. However, in traditional sectional garage doors the panels themselves are not retained in any channels, but are simply guided by the rollers in the tracks on either side of the door. When the door is opened, the interconnected door panels travel up and are guided by the rollers in the tracks on either side of the door opening. The tracks extend substantially vertically along either side of the door opening, with a slight inward inclination at the top of the door opening, then curve into the room to continue horizontally, usually along the ceiling. When the doors are closed, the lower edge of the bottom panel rests on the floor against the inside of the support walls that are located on either side of the door opening, and the lateral ends of the remaining panels similarly rest against the support walls on either side of the door opening. When the door is opened, the panels move upward and slightly away from the garage door opening as they travel up to avoid having to slide against the support walls of the door opening, which would cause unnecessary friction. As the door panels move upward, the panels are guided into the room along the ceiling following the guide tracks. When the door is fully open, the majority of the panels are all aligned overhead along the ceiling, creating an unobstructed door opening, which allows vehicles to enter the garage.

The problem is that the garage door opening takes up most of the space in the support wall, leaving little remaining support wall. This makes walls with garage doors laterally weak. Other walls have significantly more linear feet of unbroken wall, thus providing other walls with much greater shear strength compared to garage door walls, which typically provide little shear strength and thus make up the weakest walls in a garage space. During an earthquake, ground waves pass under the buildings. As a result, close to the epicenter the ground moves sideways. When the ground moves sideways, the mass of the building wants to stay in its current location while the ground moves sideways away from that point causing lateral forces on the building. Similarly, with high winds, the wind pushes sideways on the building, which causes sideways lateral forces.

Thus, with a strong wind or seismic event, the diagonal racking force that is exerted on the buildings, makes buildings with garage doors more prone to collapse due to this wall weakness. If the wind or earthquake forces exceed the lateral resisting capacity of the support walls on either side of the garage door opening, the garage door wall fails and collapses, which causes a domino effect that makes other walls successively collapse. This also applies to single panel garage doors. During large lateral forces the door panels push and bend the brackets, hinges and guide track sideways. To overcome this weakness, one approach engineers use is to design and specify lateral resisting prefabricated moment-resisting shear walls on either side of garage door openings to give them a combined similar stiffness or lateral resisting capacity as the other walls in the garage. In fact, there are four typical ways engineers provide lateral or overturning resistance to buildings. The first is site-built shear walls nailed to the framing sometimes with hold-downs at each end of each shear wall. The second is factory-built shear walls with hold-downs at each side of the door that have features that make them significantly stronger than site-built shear walls. The third makes use of steel frames (moment-Frame) with the columns indirectly bolted to the ground at both bottoms and the two tops bolted to a common beam. The engineers calculate the amount of lateral force the frame needs to resist and design it to be able to flex and spring back at the column/beam intersections. The fourth method uses diagonal brace frames from the base of one column to the top of the other column, making them unusable in door openings either in the form of a single diagonal or sometimes in the form of an X. These may comprise steel members or giant shock absorbers. They also include two columns and a cross beam along the top, but make use of the diagonals to resist the forces. All four are indirectly bolted to the ground and attached to the building above.

For single story buildings these features add a lot of cost to the building. With multi-story apartments or condominium buildings the added cost can be cost prohibitive. As a result, in San Francisco alone, there are several thousand of these older buildings that are at great risk of collapse in the event of an earthquake.

In the case of apartment buildings in cities like San Francisco, the parcel lots are typically twenty-five feet wide on the side facing the street. The garage door, consumes nine to ten linear feet of wall, and there is typically an entrance door into the building, which consumes an additional four to six linear feet. This leaves only eight to ten linear feet of wall to provide the shear resistance to seismic events and strong winds in a typical multi-story apartment or condominium building. The remaining three walls on the first floor typically are longer with no openings, which makes them a lot stronger. Engineers typically determine that the garage door walls have insufficient or negligible structural value when it comes to calculating lateral resistance needed for a building. In pre-existing buildings, in order to provide the necessary lateral strength, they therefore rely on retrofitted lateral support columns or frames. To retrofit these buildings can be cost prohibitive and the process is very disruptive to the occupants since the garage becomes unusable for some time.

### SUMMARY OF THE INVENTION

For purposes of this application the term panel door will include sectional doors, which include (1) garage doors made up of multiple horizontal panels that are hingedly connected to each other, (2) roller doors that, in a sense, comprise multiple small horizontally extending metal panels hinged to each other, and (3) bi-fold doors that move horizontally and are guided in horizontally extending channels and comprise vertically extending panels hingedly connected to each other. The term panel door also extends to single panel doors.

According to the invention, there is provided a system and method for improving the lateral strength of walls with panel doors by using sectional doors or single panel doors as shear resisting structures.

According to the invention there is provided a method for improving the shear or overturning resistance of a panel door comprising one or more panels that are guided by rollers in tracks, the method comprising securing the panels to each other in the case of a multi-panel door to withstand shear forces between the panels when the door is in a closed configuration, and releasably securing the panel(s) relative to the tracks or to separate guide channels for the panels so as to maintain the panel(s) in a closed configuration when the door panel(s) are in a closed configuration. In the case of horizontally extending panels connected to each other along their horizontal edges, releasably securing may comprise securing lateral sides of each panel by means of pins to laterally supporting or buttressing columns, either directly to the columns or to containment channels that support the lateral edges of the panels and are secured to the columns, or by holding the door panels in a closed configuration by means of one or more cables or tendons while retaining the lateral edges of the panels in containment channels.

Further, according to the invention, there is provided a multi-panel sectional garage door comprising, multiple panels movable along guide rails between a closed position in which the panels are aligned substantially horizontally on top of one another to cover a door opening, and an open position in which the majority of the panels are aligned substantially horizontally, parallel to a ceiling of the garage to expose the door opening, the panels each comprising an upper and a lower edge and two lateral edges, the upper and lower edges of adjacent panels being provided with at least one of: shear-resisting pins engageable in recesses aligned to allow the pins to be received in the recesses when the panels are in a closed configuration, and shear-resisting hinges between the panels to resist horizontal movement, the garage door further comprising means for controllably preventing the panels from moving upward when the door panels are in a closed position. The means for controllably preventing the panels from moving upward may comprise pins or recesses in the lateral edges of the panels, which are releasably engageable, respectively with recesses or pins in lateral support columns on either side of the door opening or in containment channels attached to or integrally formed with the support columns. The means for controllably preventing the panels from moving upward may instead comprise one or more motor-driven cables that are secured to at least the top panel to keep the panels in a closed position when the door is in a closed configuration. In order to ensure a snug abutment between the side edges of the panels and the lateral support columns, the support columns with their containment channels may be angled to provide a narrower opening toward the bottom of the garage door, and the lateral edges of the panels are complementarily angled and the lengths of the panels are decreased toward the bottom of the door in order to snugly abut the angled containment channels when the door is in a closed configuration. With this configuration, as the door moves upward, a gap opens up moving moving the edges of the door panels away from both buttressing columns and out of the door containment channels which allows the door panel(s) to turn unrestricted inward into the building as the door opens. The lateral edges of the panels may also, or instead, be beveled to present a longer inner face and shorter outer face to each panel so as to snugly engage similarly angled faces of the containment channels.

The containment channels may also be configured to be wider at the top than at the bottom to define a conically angled channel, and the panels may be fitted with complementarily angled, vertically-extending attachments along their lateral edges to snugly engage the angled channel when the door is in a closed configuration.

### BRIEF DESCRIPTION OF THE DRAWINGS

FIG. 1 is a back view of one embodiment of a sectional garage door arrangement of the invention;

FIG. 2A is and the door of FIG. 1 showing surface mounted pin-and-recess details;

FIG. 2B shows a three-dimensional lower view of part of the structure of FIG. 2A;

FIG. 3 shows a three-dimensional view of one embodiment of a lateral pin extraction mechanism;

FIG. 4A is a side view of the door of FIG. 1, showing the door in a closed configuration;

FIG. 4B is a side view of the door of FIG. 1, showing the door in a partially open configuration;

FIG. 5A is a side view in transparent form of another embodiment of a sectional garage door arrangement of the invention, and

FIG. 5B shows a side view of the cable or tendon arrangement shown in FIG. 5A displaying the location and path the cable or tendon travels

FIG. 6A show a side view of yet another garage door panel engagement arrangement in accordance with another embodiment of the invention showing the door in an unsealed or unengaged configuration;

FIG. 6B show a side view of the garage door panel engagement of FIG. 6A, showing the door in a sealed and engaged configuration;

FIG. 7 shows the arrangement of FIG. 6A from the top;

FIG. 8A shows a prior art wall with paneling nailed to the framing;

FIG. 8B shows the effect on a wall when the paneling is nailed to the frame during and after an earthquake causing the nails to bend prior to failure;

FIG. 9 shows the effect of lateral forces during an earthquake on a prior art sectional garage door;

FIG. 10 shows the effect of lateral forces during or after an earthquake on a sectional garage door of the invention, and

FIG. 11 shows a three-dimensional view of inserts for use with another embodiment of the garage door panels of the invention.

### DETAILED DESCRIPTION OF THE INVENTION

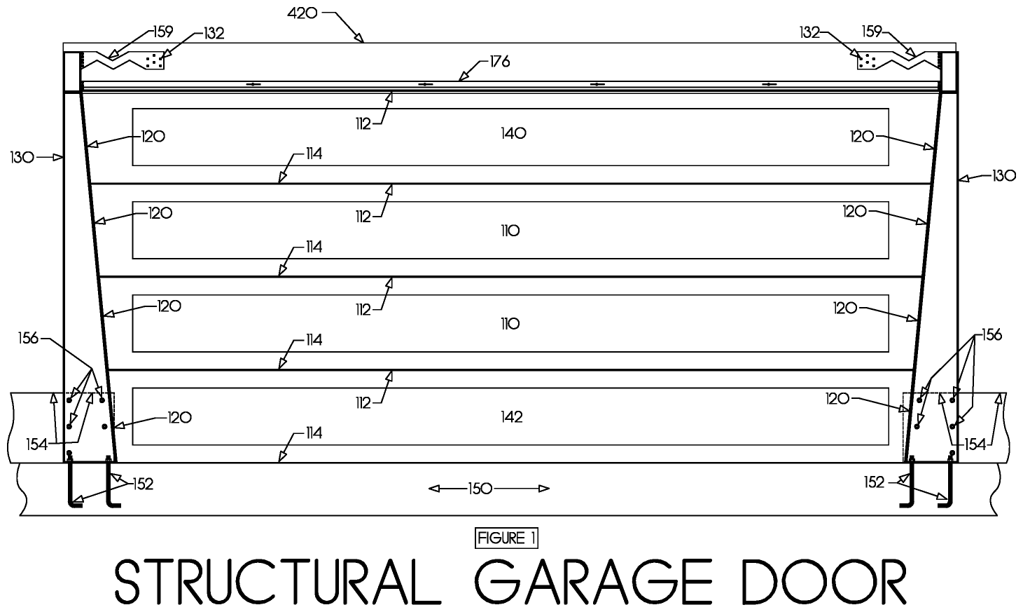

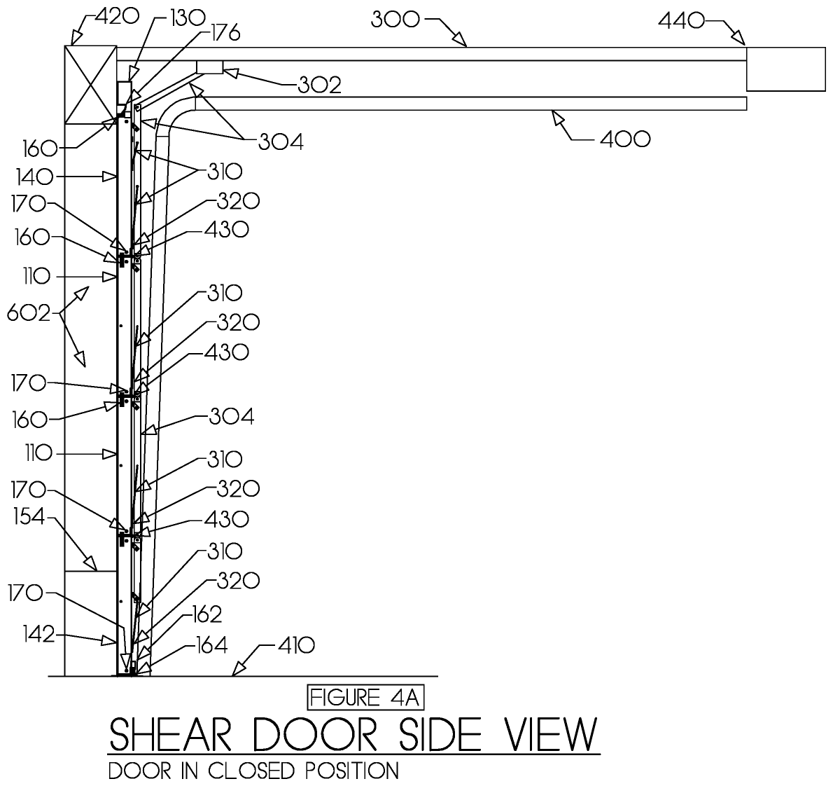

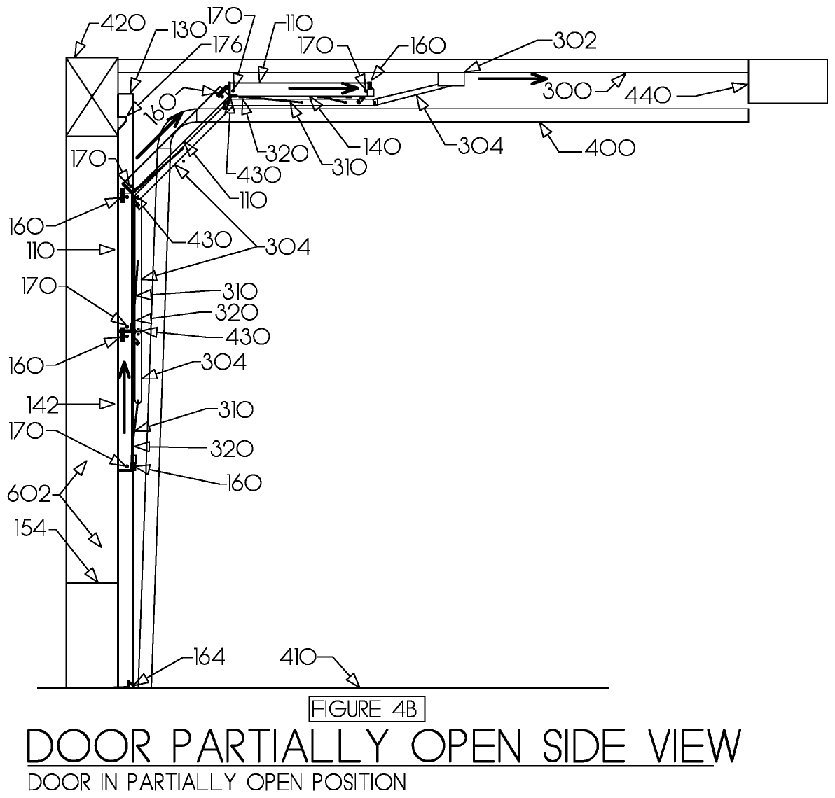

One embodiment of a sectional garage door of the present invention is shown in FIG. 1. In this embodiment the garage door comprises 4 panels 140, 110,110, and 142 (referred as door panel), each of which has an upper edge 114 and a lower edge 112, as well as two angled lateral (side) edges 120. The lateral edges are angled with the upper edge of each panel being longer than its lower edge, to complementarily engage a similarly angled inner face of a buttressing column 130 (also referred to herein as a support column 130) that is provided on each side of the door opening (also referred to here as a brace frame column). It will be appreciated that in order to accommodate the angled inner faces of the support columns 130, the top of the top panel 140 (as viewed when the door is in a closed configuration) will be the longest panel measurement, while the bottom of the lowest panel 142 will be the shortest panel measurement. By providing angled columns or columns with an angled inner face and complementarily angled lateral edges 120 for the door panels, as shown in FIG. 1, the lateral panel edges 120 are ensured to rest flush with the angled faces of the columns 130 when the door is in its closed configuration, as shown in FIG. 1, thereby avoiding any play between the lateral edges of the panels and the support columns 130 during seismic or high wind activity. The columns 130 are add-ons that are a feature of the present embodiment of the invention. The columns or brace frames have upper brace frame extensions 132 made of malleable and/or deformable area 159 or other configuration that allows some give when forces are exerted on the columns, brace frames, or doors. The upper brace frame extensions 132, which are above the header shear plate allow the columns 130 to be bolted to an existing or new door header beam 420 or building above (also shown in FIG. 4). In this case the columns 130 are connected to the garage door opening header or building above and indirectly secured to the ground 150 sometimes by means of anchor bolts 152 into cement grade beams (not shown), connected to the structure as part of the present embodiment of the invention. FIG. 1 also shows the foundation 154 on either side of the door opening, with bolts 156 for securing the base of the columns 130 to the foundation stem walls.

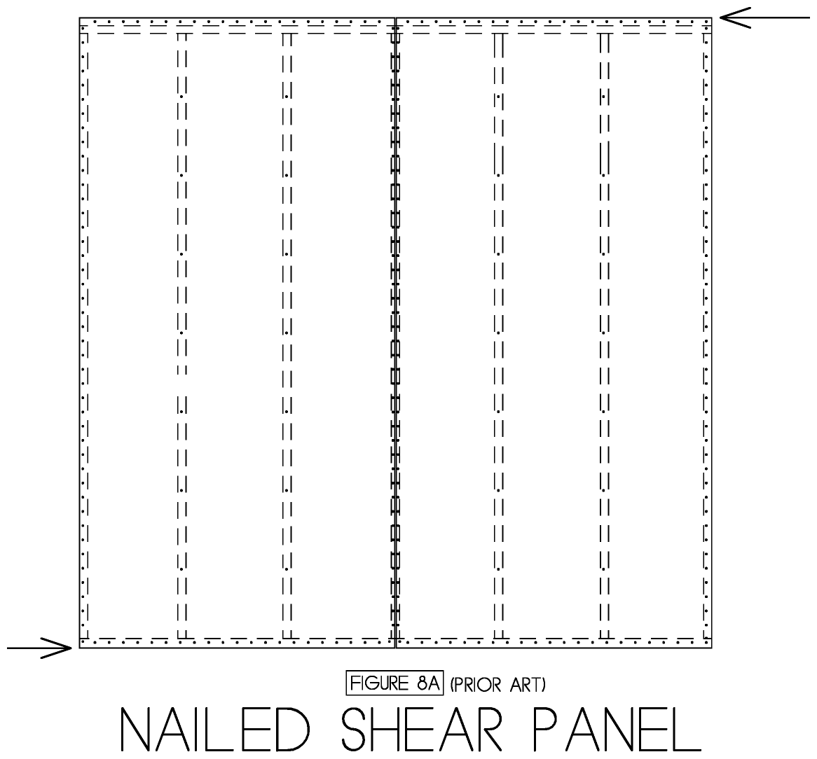

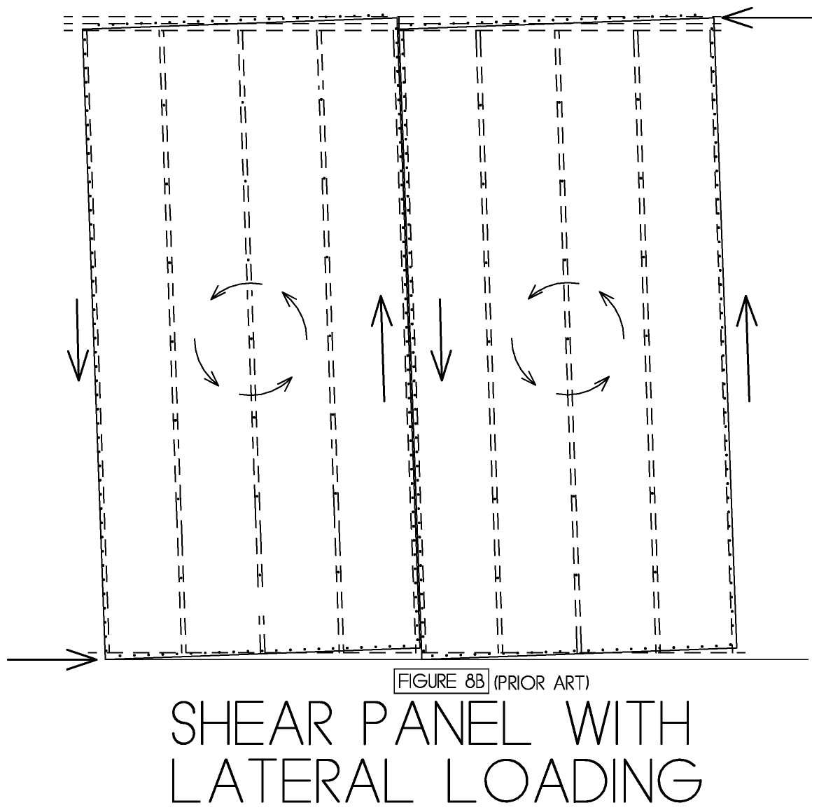

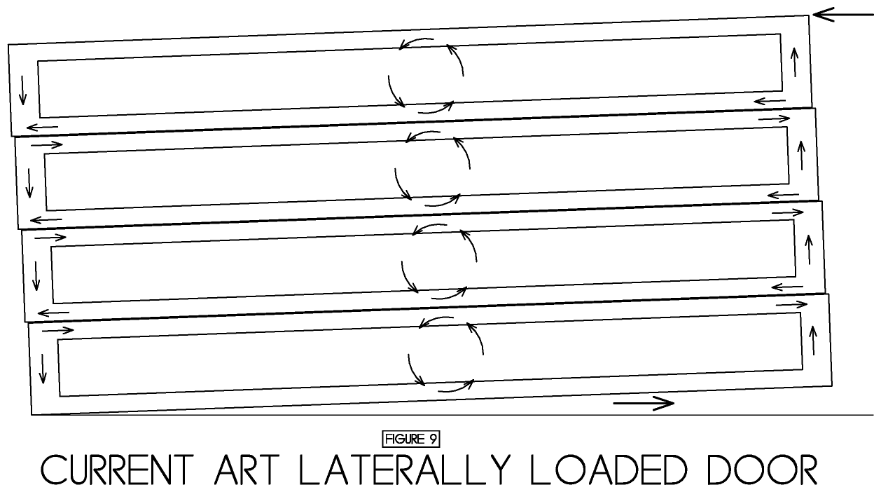

In a typical, conventional framed wall such as that shown in FIG. 8A, much of the shear strength is created by nailing paneling to the wall framing, (sometimes with hold-downs installed at the ends) which resist the seismic or wind shear forces exerted on the building and panels. However, when high shear forces are exerted on the wall framing frame, e.g., during an earthquake or high wind, the shear forces on the panels would push the upper ends in one direction and the lower ends in the opposite direction, effectively causing rotational forces on the shear wall panels as shown in FIG. 8B. This will cause the nails holding the paneling to the frame, to bend as depicted in FIG. 8B. At this point the shear panels are still connected to the framing, which constitutes the occupant survivability mode where the building begins to crumble but prior to collapsing.

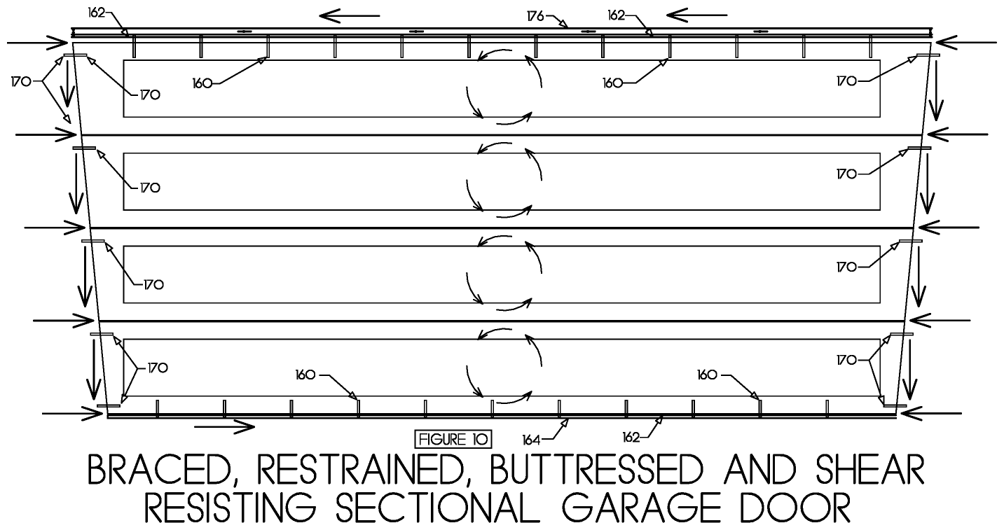

It will be appreciated that in the case of a garage door wall opening there typically is insufficient lateral shear support along the wall. When lateral shearing forces, e.g., in an earthquake or high winds, is exerted on a sectional garage door as shown in FIG. 9 in an earthquake it can move the ground sideways at the bottom and the building imposing lateral forces against the top of the wall in an opposite direction, effectively causing the panels to try to rotate. The present invention therefore provides the necessary shear and rotational resistance by making use of the panels of the garage door as shear-resisting component or assembly. Since the door has to be able to move up and down when it opens and closes, it cannot, however, be secured to any framing as in a conventional wall. Instead, the present invention shearingly secures the panels to each other to resist shear movement between the panels and thus effectively creating a single shear-resisting door structure. The present invention further releasably secures this door structure in the down (closed) configuration when the door is down to prevent it from rotating causing the ends to move upward when shear or rotational forces are exerted on it.

Preventing the door from moving upward can be achieved in different ways as discussed below.

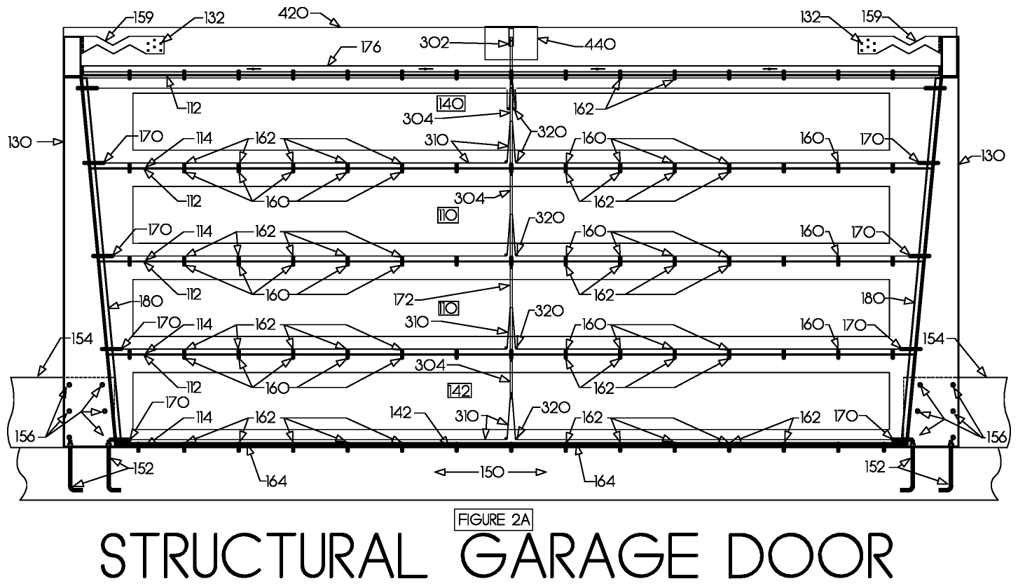

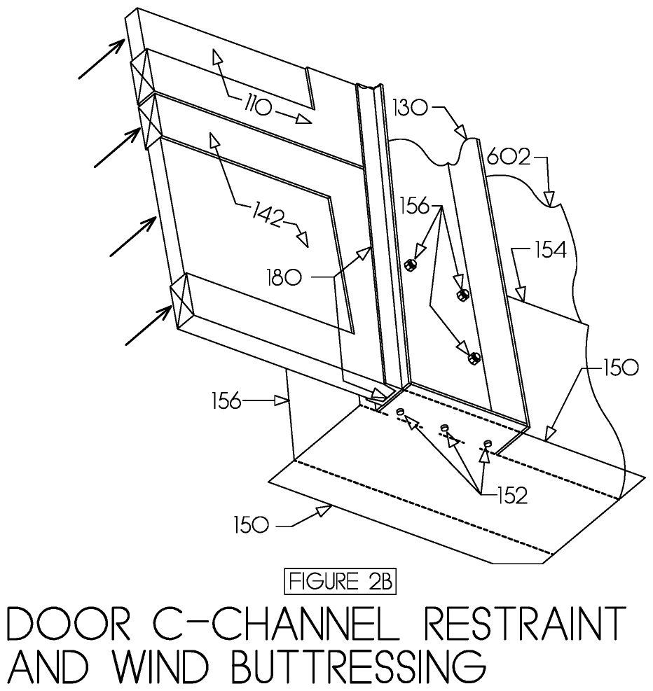

One such mechanism to releasably secure the door structure in the closed configuration and prevent it from moving upward when shear forces are exerted on it, is shown in FIGS. 2A and 2B. Also, in FIGS. 1 and 2A, it shows the columns 130 at each end of the door which gives the design something for the door to buttress against. FIG. 2A shows the panels and ground in partially transparent mode so that the various pins, anchor bolts, foundation and grade beam are visible. In this embodiment, the door panels 110, 140 and 142 (referred as door panels hereafter) are secured to each other to resist shearing forces (in other words to prevent the panels moving laterally relative to each other) by means of pins 160 that extend from the top edge of each door panel, 110, and are received in recesses in the form of slots 162 in the lower edge of the adjacent door panel. In the case of the lowest panel, pins also extend from the lower edge to be received in slots in the door sill plate 164 (not shown). By defining the receiving recesses in the upper edges as slots 162 that extend partially or all the way through the thickness of the panel, it will be appreciated that the pins 160 can pivot freely when they move around the bend along the guide rails (see FIG. 4B) from their vertical (closed) configuration to their horizontal (open) configuration. In the case of the bottom panel 142, the pins 160 are received in holes or slots 164 in a slotted, shear resisting sill plate 164 (not shown) attached to the floor or grade beam 150 shown. It will be appreciated that the number and shape of the pins may be different in different embodiments and that the pins may instead extend from the lower edges of the panels, to engage with slots in the adjacent upper edges of the adjacent panels. The inter-panel shear connections can also be accomplished by installing shear resistant hinges (not shown) where the panels abut adjoining panels.

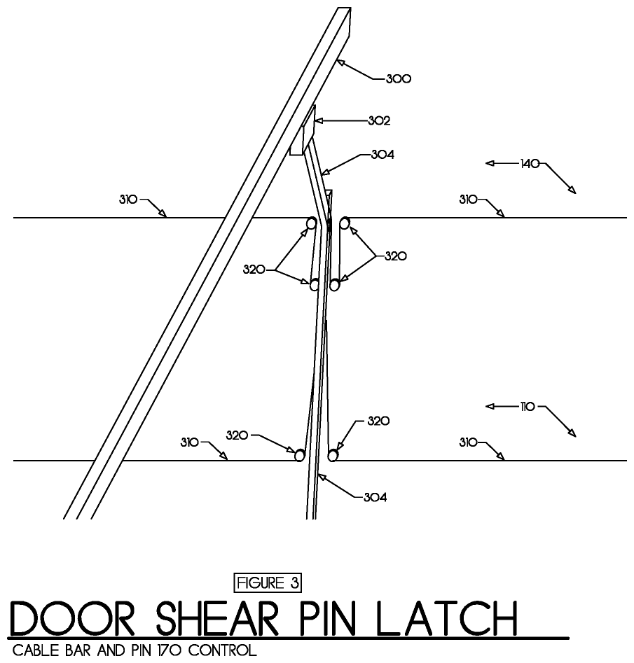

In this embodiment the door structure defined by the door panels 110 is secured relative to the columns 130 by means of spring-loaded laterally extending pins 170, which extend from the lateral edges of the panels and are received in recesses in the column 130. In their extended state, the laterally extending pins 170 extend into the recesses in the column 130 and prevent the panels from moving upward. When the door has to be opened, the pins 170 are first retracted by against their spring loading by means of cables or tendons (referred to as cables) as is discussed in greater detail below with respect to FIG. 3. When the door closes, the spring-loaded pins slide along the inner surfaces of the columns 130 until they align with engagement recesses (openings) where they slide into the openings, securing the door. It will be appreciated that multiple pins 170 can be provided at each lateral edge of each panel or a single pin per edge may suffice. The spring-loaded pins 170 can be recessed within the body of the panels or can be surface mounted to the panels. In the present embodiment an upper and a lower pin 170 is provided on each lateral edge of each panel. In one embodiment only the top panel 140 is secured to the columns 130 by means of pins 170, thereby preventing all of the panels from moving upward when the door is in its closed configuration and the pins 170 are in their extended configuration. It will also be appreciated that the pins may instead extend from the columns 130 and extend into recesses in the lateral edges of the panels 110.

FIG. 2B also shows a lower perspective view of one end of a door contained in a containment channel 180 that can add greater door resistance in a high wind or seismic event and can also prevent the panels from buckling out of plane from the columns 130 when the door is closed.

FIG. 3 shows one embodiment of a pin retraction mechanism for retracting the pins 170 from their recesses in the columns 130. FIG. 3 shows the door opener track 300 with a travel block 302 that moves the panels 110 up and down by means of connection rod 304. As shown in this embodiment, latch pull cables 310 extending around pulleys 320, are also connected to the travel block 302, and are attached to the spring loaded laterally extending pins 170 (not shown here) to retract the pins when the block 302 is first moved. The connection rod 304 is connected to the block 302 by means of a sliding slot or pivot mechanism that allows the block 302 to pull on the cables 310 before pulling on the door panels. Thus, the pins 170 are retracted before the door panels start moving upward. In the case of a shaft drive door opener, gear driven motor(s) rotate the shaft, which raises and lowers the door. In order to disengage the pins, the shaft will first disengage the pins during initial rotation of the shaft, before it starts to lift the door.

FIGS. 4A and 4B show the door of FIG. 3 from the side. In this embodiment the pins 160 extend from the lower edges of the door panels, and are received in slots 162 in the upper edges of the adjacent panels. FIGS. 4A and 4B show how the guide rails 400 that guide the door as it opens and closes, are not entirely vertical along the door opening and then make a bend at the top to continue substantially horizontally. As discussed in the Background section, the rails are angled closer to the outside toward the lower end of the opening to ensure the door securely closes the opening, while avoiding unnecessary friction as the door opens. FIGS. 4A and 4B also show the cement floor 410 in which the grade beam (not shown) is recessed into the ground below, and the door header beam 420. Hinges 430 pivotally connect adjacent door panels to each other. As shown, a motor drive unit 440 moves the travel block 302 by means of a belt, chain or screw as is known in the art. FIG. 4A also shows a header bar 176 (also referred to as a header shear bar) that is between the columns 130 and bears against the door header beam 420 If the header shear bar 176 were firmly connected to the door header beam 420 or building, the connection to the door header beam 420, would prevent the brace frame extensions 132 from providing a resilient connection to the building. If the header shear bar 176 is only connected to the top of the columns 130 and the top of the columns 130 are also independently connected to the door header beam 420 through the resilient brace frame connection 132, there is a resilient connection between the garage door assembly and the building order to In order to prevent the header shear bar 176 from warping, deforming or bowing, when forces are imposed on it, it needs to allow the building to move independently from the shear header bar and columns. This is accomplished by having slotted connections between the header shear bar and door header beam. The only firm connection to the header beam is through the brace frame extensions 132 which are resilient. In another embodiment the connections between pins 160 and header shear bar 176 has slotted, recesses that allow a shear connection between the top of the door panel to the header shear bar 176 with no rigid connection to the door header beam 420. This configuration allows horizontal differential movement between the door assembly and the building with progressively increasing resistance as the differential distance increases, thus more closely matching the shear resistance of other portions of the building.

Having the support columns (brace frames) at both ends of the garage door allows the door to buttress against the brace frames adding shear and uplift resistance.

When the door is pinned to the brace frame 130, anchored to the floor 164 and header shear bar 176, it has a unifying effect that can then be connected to the building at the top to increase the lateral strength of the garage door wall.

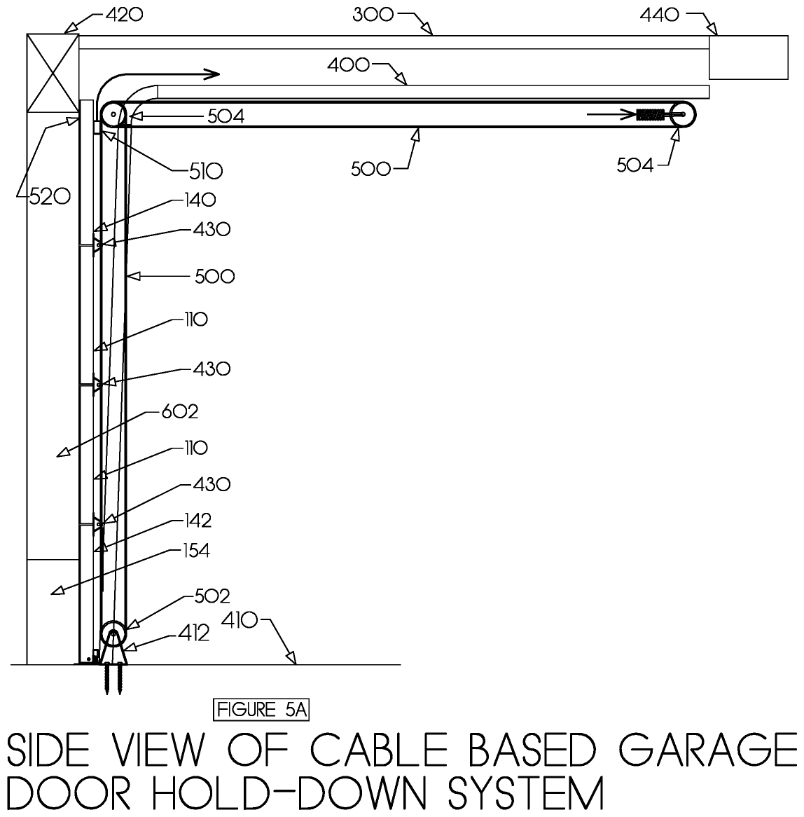

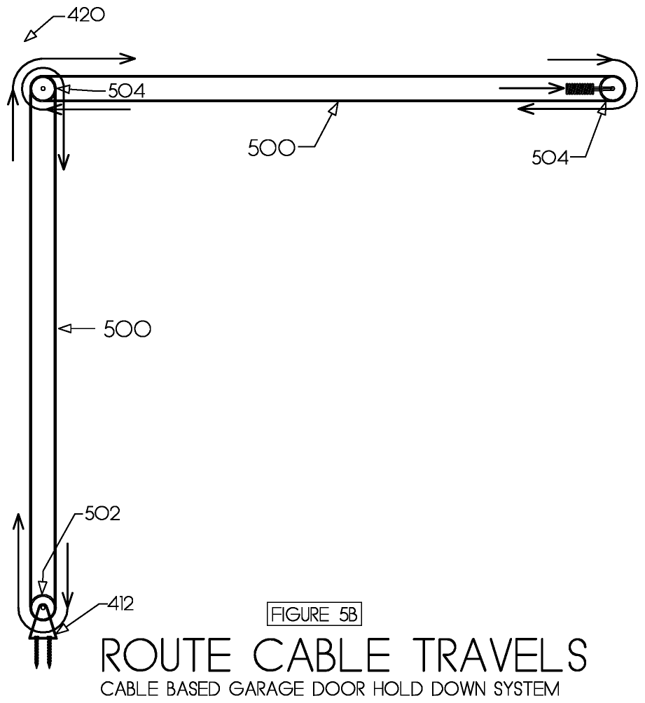

Another embodiment of the invention is shown in FIG. 5, which shows a different means for holding the door panels down when the door is in a closed configuration. In this embodiment, cables, chains, tendons or some form of tension material (referred to for simplicity hereafter collectively as cables) 500 extend around lower pulleys 502 and upper guide pulleys 504 on both sides of the door structure. The lower pulley frame 412, in this embodiment is attached to the floor, ground or foundation as shown on FIG. 5. The cables 500 are secured to at least the upper panel 520 by means of attachment brackets 510. When the door opens and closes, the cables 500 may move freely about the pulleys 502 and 504. The cable may be motor driven by the door opener 440 (FIG. 4), or may instead be driven by one or more separate motors. One of the pulleys, e.g., the bottom pulley, or multiple pulleys can be locked or prevented them from rotating when the door is in its closed configuration, which in turn prevents the cable from moving, thereby preventing the door from moving upward in an event. Thus, the bottom and or other cable pulleys, when locked or prevented from rotating, will create resistance to movement and hold the door down when there are upward forces imposed on the door from a seismic or wind event. In one embodiment a chain is used, and instead of locking the pulleys the drive motor driving the chain is locked, e.g., due to the internal electric drive motor resistance or latching mechanism when the motor is not rotating.

It will be appreciated that the cable 500 may also be used in addition to the laterally extending pins 170, as is shown in this embodiment.

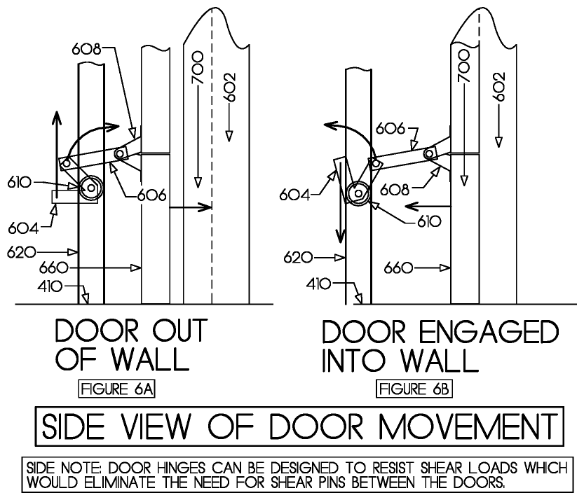

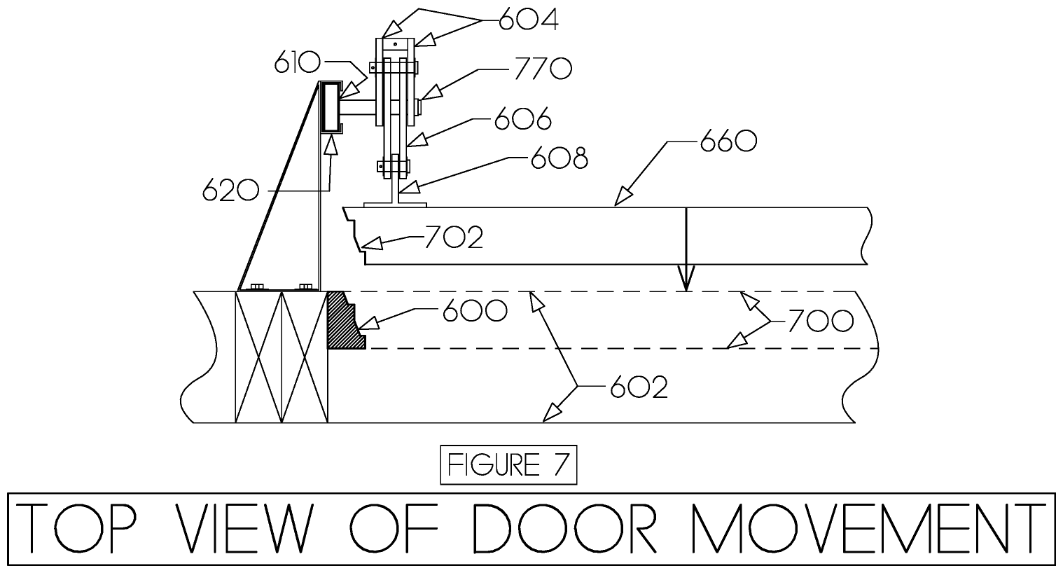

Another embodiment of the present invention is shown in FIGS. 6A, 6B, and 7, which shows a different arrangement to ensure that the door panels fit snugly into the opening defined by the garage door side walls and door header beam 420. In this embodiment, instead of or in addition to making use of angled support columns or angled inner faces to the support columns as discussed in the above embodiments, the present embodiment provides a door recess frame 600 formed in or mounted to the garage door side walls 602, floor 150, and door header beam 420. The recess frame 600 defines a wider recess toward the inside than the outside, and the lateral edges of the door panels are similarly shaped to complementarily engage with the recess in the frame 600. FIG. 7, which shows the arrangement from the top, shows the shape of the recess 700 in the present embodiment, in the frame 600. The lateral edges 702 of the door panels are shaped to complementarily engage the recess 700. This frame configuration extends along both sides of the door and along the top of the door. Thus, in order to snugly move the door into the recess, to sealingly engage the door frame when the door is in its lowered position, a separate mechanism is required to horizontally move the door into a sealed or engaged configuration once the door is in its lowered closed position. In the present embodiment, this is achieved by means of L-shaped brackets 604 (FIGS. 6A and 6B) that pivot around the guide wheels 610, which run in the guide tracks 620. The L-shaped brackets 604 each in turn engage a hinged elbow (push-pull bar) 606, which is also hinged at its opposite end to a door hinge bracket 608 on the door panel 660. By rotating the L-shaped bracket 604 using a cable attached to the free leg of the bracket 604, the elbow 606 can be moved outward or inward to push the door panel into the recess (FIG. 6B) or away from the recess 600 (FIG. 6A).

FIG. 7 also illustrates the mounting of the track guide wheels 610, which are rotatably mounted in tubes or bearings 770 to accommodate lateral movement of the panels as they move up or down in the guide tracks 620.

In the above embodiments, the panels were secured to each other by means of pins and slots to withstand lateral forces when the door is in its closed position. In another embodiment the pins, which resist shear forces, can be replaced with shear-resisting hinges between the panels.

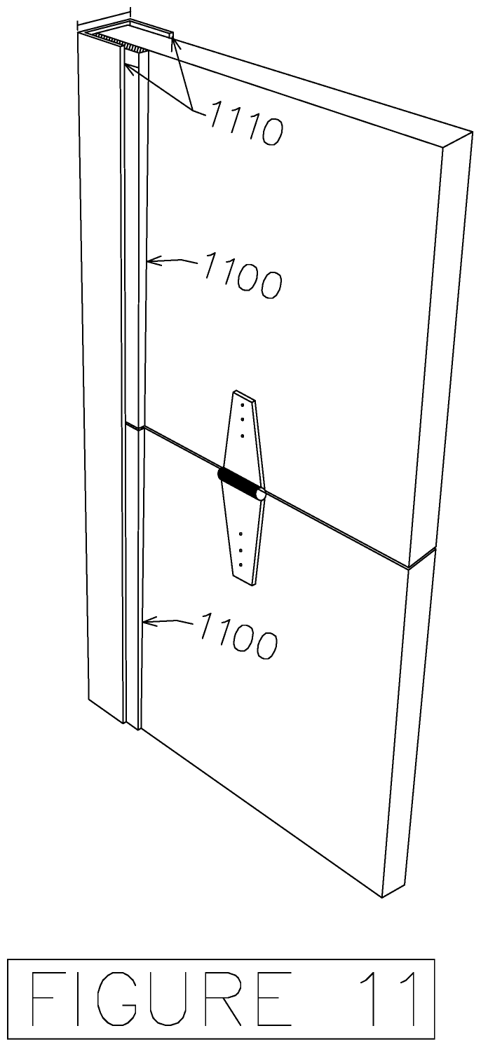

The effect of the shear-resisting garage doors of the invention, is shown in FIG. 10. Unlike the prior art door of FIG. 9, the door of the invention does not lift up or shift sideways from the floor or panels when lateral forces are exerted at the top or bottom of the door. The pins 170, in this embodiment, prevent the door from moving upward on either of the two sides. Also, the shear-resistant pins 160 or shear-resting hinges between the panels prevent the panels from moving laterally past each other. Thus, the door resists rotational forces and acts as a shear-resisting panel or assembly in or against the door opening when the door is in a closed configuration. Both the door sill plate 164 and the header shear bar 176 can also add indirect horizontal shear resistance between the door assembly and the building.

Yet another implementation of a sectional door, which is also applicable to a single panel door, is shown in FIG. 11. Tapered inserts 1100 are attached to the inside edges of the individual panels (in the case of a sectional door) or to the single panel. The channel frame 1110 is, in turn, tapered from wider at the top to narrower at the bottom to complementarily engage the panel(s) with their tapered inserts 1100 when the door is in its down configuration. Thus when the door is down it eliminates any play between the edges of the door panel(s) and the channel frame, thereby resisting small inward and outward movements of the door during high winds or during an earthquake.

While the present invention has been described with respect to specific embodiments, it will be appreciated that it can be implemented in different ways without departing from the scope of the invention.

What is claimed is:

1. A method for improving the shear and overturning resistance of a panel door comprising one or more panels that are guided by rollers in tracks, the method comprising
securing the panels to each other in the case of a multi-panel door to withstand shear forces between the panels when the door is in a closed configuration, and
releasably securing the one or more panels to buttressing columns or to containment channels that are secured to or integrally formed with the buttressing columns, wherein the for containment channels act to support lateral edges of the panels, and the releasable securing releasably retains the one or more panels in a closed configuration when the one or more panels are in a closed configuration.

2. The method of claim 1, wherein, in the case of horizontally extending panels connected to each other along their horizontal edges, the step of releasably securing the one or more panels comprises securing lateral sides of each panel by means of pins to the buttressing columns or to the containment channels, or holding the panels in a closed configuration by means of one or more cables or tendons while retaining the lateral edges of the panels in containment channels.

3. A multi-panel sectional garage door comprising,
multiple panels movable along guide rails between a closed position in which the panels are aligned substantially horizontally on top of one another to cover a door opening that is framed on both sides by a support column, and an open position in which the majority of the panels are aligned substantially horizontally, along a ceiling of the garage to expose the door opening, the panels each comprising an upper and a lower edge and two lateral edges, the upper and lower edges of adjacent panels being provided with at least one of: shear-resisting pins engageable in recesses aligned to allow the pins to be received in the recesses when the panels are in a closed configuration, and shear-resisting hinges between the panels to resist horizontal movement, the garage door further comprising means for controllably preventing the panels from moving upward when the door panels are in a closed position.

4. The multi-panel sectional garage door of claim 3, wherein the means for controllably preventing the panels from moving upward comprises pins or recesses in the lateral edges of the panels, which are releasably engageable, respectively with recesses or pins in the lateral support columns on either side of the door opening or in containment channels attached to, aligned with, or integrally formed with the support columns.

5. The multi-panel sectional garage door of claim 3, wherein the means for controllably preventing the panels from moving upward comprises one or more motor-driven cables that are secured to at least the top panel to keep the panels in a closed position when the door is in a closed configuration.

6. The multi-panel sectional garage door of claim 4, wherein the containment channels are angled to provide a narrower opening toward the bottom of the garage door opening, and the lateral edges of the panels are complementarily angled and the lengths of the panels are decreased toward the bottom of the door in order to snugly abut the angled containment channels when the door is in a closed configuration.

7. The multi-panel sectional garage door of claim 4, wherein the lateral edges of the panels beveled from their inner to their outer faces to present a longer inner face and shorter outer face so as to snugly engage similarly angled faces of the containment channels.

8. The multi-panel sectional garage door of claim 4, wherein the containment channels are configured to be wider at the top and taper to be narrower at the bottom to define a tapered channel, and the panels are fitted with complementarily angled, vertically-extending attachments to their inner or outer faces along their lateral edges to snugly engage the tapered channel when the door is in a closed configuration.

9. A multi-panel sectional door comprising,
multiple panels movable along guide rails between a closed position in which the panels are aligned edge-to-edge to cover a door opening, and an open position in which the panels are moved along the guide rails to expose the door opening, the panels each comprising adjacent engaging edges, which engage with adjacent panels in the closed configuration, and two guided edges that are guided by the guide rails, the engaging edges of adjacent panels being provided with at least one of: shear-resisting pins engageable in recesses aligned to allow the pins to be received in the recesses when the panels are in a closed configuration, and shear-resisting hinges between the panels, the door further comprising means for controllably maintaining the door in a closed position.

10. The multi-panel sectional door of claim 9, wherein the means for controllably maintaining the door in a closed position, comprises pins or recesses in the guided edges of the panels, which are releasably engageable, respectively, with recesses or pins that are provided in the guide rails or in separate containment channels for the guided edges of the panels.

11. The multi-panel sectional door of claim 9, wherein the means for controllably maintaining the door in a closed position, comprises one or more motor-driven cables that are secured to one or more of the panels to controllably maintain the panels in a closed position when the door is in a closed position.
